(19) United States
(12) Patent Application Publication
(10) Pub. No.: US 2008/0315576 A1
(43) Pub. Date: Dec. 25, 2008

(54) Fluid Line Coupling

(75) Inventors: Erminio Moretti, Grenoble (FR); Jacques Boyer, St. Martin d'Uriage (FR); Albert Raymond, Claix (FR)

Correspondence Address: BAKER & DANIELS LLP;111 E. WAYNE STREET, SUITE 800, FORT WAYNE, IN, 46802, US

(73) Assignee: A. Raymond Et Cie, Grenoble (FR)

(21) Appl. No.: 12/279,920

(22) PCT Filed: Mar. 22, 2007
(86) PCT No.: PCT/EP07/02529

§ 371 Date: Aug. 19, 2008

(30) Foreign Application Priority Data
Apr. 26, 2006 (DE) 10 2006 019 257.5

(51) Int. Cl. F16L 55/00

(52) U.S. Cl. 285/82

(57) ABSTRACT

The invention relates to a fluid line coupling and comprises a receiving part (1) as well as a fixing assembly (15) for the fixation of an insertion part (10). The fixing assembly has a retaining part (17) which is, in a steady state, located in the receiving space (4) of the receiving part (1) and is equipped with pivotable support wings (22, 23) engaging behind the existing front coil (14) which is located on the insertion part (10). Said fixing assembly also features a locking element (16) which is movably connected to the retaining part (17) and has, along with the receiving part (1), elements of a blocking assembly which impede the movement of the locking element (16) from an extended to a retracted position, if the insertion part (10) is not positioned accordingly. Thus, an easily attainable and stable fixation of the insertion part (10) in the receiving part (1) is achieved.

### CROSS-REFERENCE TO RELATED APPLICATION

This application is a U.S. National Phase patent application based on International Application Serial No. PCT/EP2007/002529 filed Mar. 22, 2007, the disclosure of which is hereby explicitly incorporated by reference herein.

### BACKGROUND OF THE INVENTION

1. Field of the Invention

The invention is directed to a fluid line coupling.

2. Description of the Related Art

One fluid line coupling is known from DE 10 2004 038 912 B3. The prior fluid line coupling comprises a receiving part, into which an insertion part configured with an end union can be inserted. A fixing arrangement for locking the insertion part in the receiving part is configured in one piece in the form a clamp-like security part that can be moved between an extended position and a retracted position and that comprises two arms connected to each other via a transverse portion, and further comprises a retaining portion disposed radially inward of the transverse portion.

### SUMMARY OF THE INVENTION

The present invention provides a fluid line coupling having a blocking assembly configured on its receiving part and on its security part, such that when the insertion part is not properly inserted into the receiving part, elements of the blocking assembly are engaged with one another in such a way that the security part is prevented from shifting from the extended position to the retracted position, while when the end union is disposed in the region of the arms, the engagement between the elements of the blocking assembly is released and the security part can be moved into the retracted position, in which the retaining portion configured on the security part engages behind the end union. A relatively simple means of ascertaining the proper arrangement of the insertion part in the receiving part is obtained in this way, since the security part can be in the retracted position only if the insertion part is properly arranged in the receiving part, taking the elements of the blocking assembly out of engagement.

The present invention provides a fluid line coupling that is distinguished by being particularly easy to manipulate and produce, and by being usable under difficult conditions in securing the insertion part in the receiving part and in verifying the correct arrangement of the insertion part in the receiving part.

By virtue of the fact that in the fluid line coupling according to the invention, the fixing arrangement has two separate components, namely the retaining part and the security part, for the function of retaining the insertion part and for the function of indicating the correct arrangement of the insertion part in the receiving part, each component can be optimally designed for its assigned function, it being the case that the retaining part, which can be quite sturdily dimensioned, remains in an embracing position in a stationary state and need not be moved in a radial direction, while the security part, which is provided solely to perform the function of confirming the successful insertion of the insertion part into the receiving part, can be configured as more delicate and thus as more easily movable.

In one form thereof, the present invention provides a fluid line coupling, including a receiving part for receiving an insertion part configured with an end union, and including a fixing arrangement having a security part, which is configured with two security arms, and at least one retaining portion, the security part being insertable into a receiving space of the receiving part and movable at right angles to an insertion direction of the insertion part between an extended position and a retracted position, and the receiving part and the security part including a blocking arrangement, wherein if the insertion part is not properly inserted in the receiving part, blocking elements of the blocking arrangement which are configured on the receiving part and on the security part are engaged with one another in such a way that the security part is prevented from shifting from the extended position into the retracted position, and wherein when the end union is disposed in the region of the security arms, the engagement between the elements of the blocking arrangement is released and the security part can be moved into the retracted position, it being the case that in the retracted position, the or each retaining portion engages behind the end union, characterized in that the fixing arrangement further includes a retaining part on which the or each retaining portion is configured and which in a stationary state is disposed in the receiving space in an embracing position, and in that the security part is displaceably connected to the retaining part.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is an exploded perspective view of an exemplary embodiment of a fluid line coupling according to the invention, comprising a fixing arrangement having a retaining part and a security part;

FIG. 2 is a cross-sectional representation of the exemplary embodiment according to FIG. 1 in the region of the fixing arrangement during the insertion of an insertion shaft of an insertion part, with the security part in an extended position;

FIG. 3 shows the arrangement according to FIG. 2 with an end union configured on the insertion part in a position located in the region of the fixing arrangement during the insertion of the insertion part;

FIG. 4 is a longitudinal section of the arrangement according to FIG. 3;

FIG. 5 shows the arrangement according to FIGS. 2 to 5 immediately after the end union has passed through the fixing arrangement;

FIG. 6 is a longitudinal section of the arrangement according to FIG. 5;

FIG. 7 shows the exemplary embodiment according to FIGS. 1 to 6 with the security part in a retracted position and with an electrical measuring arrangement for detecting the retracted position of the security part;

FIG. 8 is a sectional view of an exemplary embodiment modified in the region of the receiving part by comparison to the exemplary embodiment according to FIGS. 1 to 7;

FIG. 9 is a sectional view of an exemplary embodiment modified in the region of the security part by comparison to the exemplary embodiment according to FIGS. 1 to 7; and

FIG. 10 is a section of an exemplary embodiment modified in the region of the security part by comparison to the exemplary embodiment according to FIGS. 1 to 7 and the exemplary embodiment according to FIG. 9.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

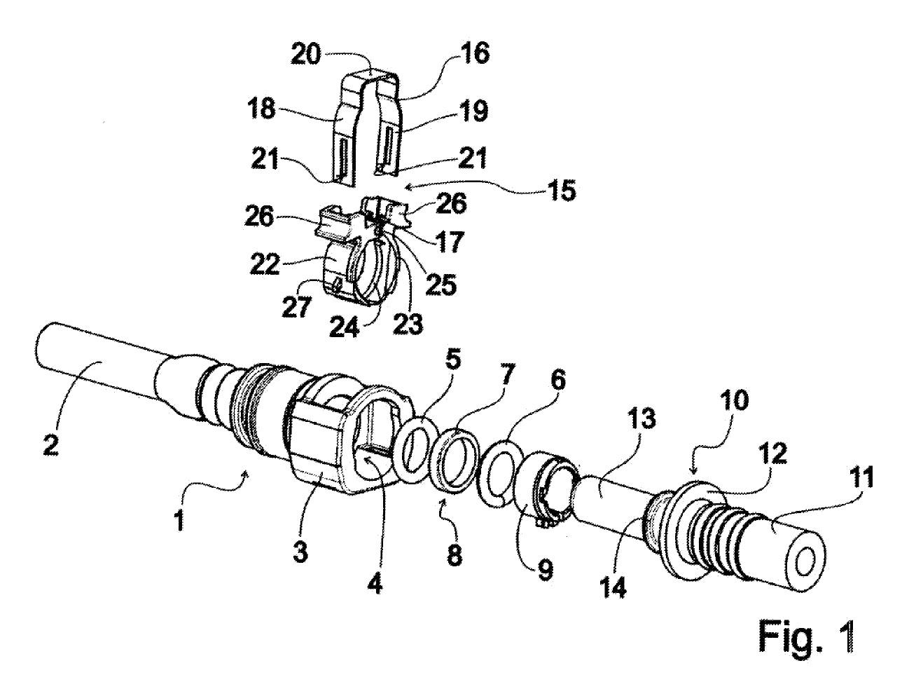

FIG. 1 is an exploded perspective view of an exemplary embodiment of a fluid line coupling according to the invention. The inventive fluid line coupling comprises a receiving part 1 that can be tightly connected at one end to an end of a fluid line 2, as illustrated in FIG. 1. At the other end, receiving part 1 has a security body 3, which surrounds a receiving space 4.

In this exemplary embodiment, a first sealing ring 5, a second sealing ring 6, and an intermediate ring 7, disposed between sealing rings 5 and 6, of a sealing arrangement 8 can be inserted into receiving part 1 through receiving space 4, proceeding on into a sealing space confronting the fluid line 2. Sealing arrangement 8 is sealed off from receiving space 4 by a spacer 9.

Also depicted in FIG. 1 is an insertion part 10 which is to be inserted into receiving part 1, and which can be connected by an elongated line shaft 11 to an end of another fluid line, not shown in FIG. 1. Configured in roughly the middle of insertion part 10 is a fully circumferentially extending stop collar 12, which serves, among other things, as an abutment for the end of the fluid line. Configured on the opposite side of stop collar 12 from line shaft 11 is an elongated, substantially cylindrical insertion shaft 13, comprising, in its end region adjacent stop collar 12, a fully circumferentially extending end union 14 whose diameter is smaller than the diameter of stop collar 12.

The inventive device according to FIG. 1 further comprises a fixing arrangement 15 which can be inserted into the receiving space 4 and arranged as intended therein, and which in the exemplary embodiment shown is formed by a security part 16 and a retaining part 17.

In this exemplary embodiment, security part 16 is made of metal, preferably of stamped sheet metal, and is substantially U-shaped, with two oppositely disposed security arms 18, 19, connected to each other via a flat top portion 20. Security part 16 thus has some resilient flexibility and is very resistant to high temperatures. The security arms 18, 19 are configured to converge toward each other in the direction heading away from top portion 20, causing them to be biased toward each other when in a substantially parallel or splayed-apart arrangement. It can also be seen from FIG. 1 that longitudinal slits 21 have been introduced as openings in the ends of security arms 18, 19 directed away from top portion 20.

The retaining part 17 is configured as two parts in this exemplary embodiment, with two separate retaining wings 22, 23, each roughly semicircular in shape, each having on its inner side facing the other a respective retaining portion 24 that protrudes radially inwardly in an approximately circular-arc shape and is beveled in the insertion direction of insertion part 10. With a view toward both high stability and high mobility, the retaining wings 22, 23 are connected to each other at one end by an articulation 25 that allows them to pivot radially inward and outward, each retaining wing 22, 23 having, adjacent the articulation 25, an actuating structure 26 in the form of a protuberance arrangement that can preferably be grasped well with the fingers.

Finally, retaining wings 22, 23 each have on their radially outwardly disposed outer sides a respective holding lug 27, which protrudes radially outward and is angled away from articulation 25, and which is dimensioned to engage in a longitudinal slit 21 formed in a respective one of the security arms 18, 19 when security part 16 is properly guided by its security arms 18, 19 through insertion openings provided between articulation 25 and actuating structure 25 and the security arms 18, 19 bear radially outwardly against the retaining wings 22, 23. Security part 16 and retaining part 17 are thus reliably connected to each other.

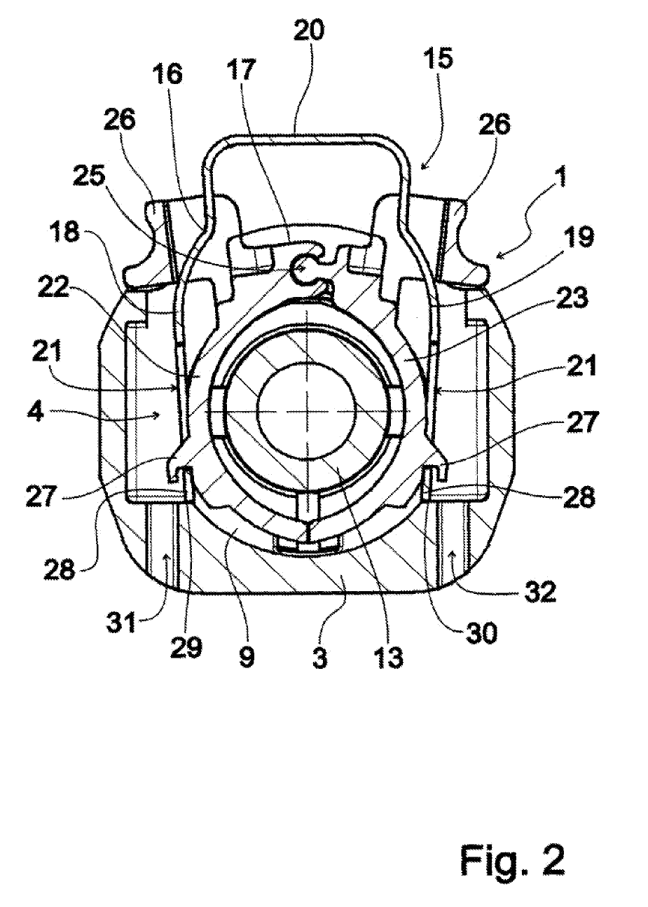

FIG. 2 is a sectional view of the exemplary embodiment according to FIG. 1 in the region of fixing arrangement 15 during the insertion of insertion shaft 13 of insertion part 10, security part 16 being in an extended position. As is apparent from FIG. 2, the outer diameter of insertion shaft 13 is smaller than the inner diameter of the ring formed by retaining wings 22, 23, which ring encircles insertion shaft 13 in this stationary embracing position of retaining part 17. In the extended position of security part 16, top portion 20 is spaced apart from articulation 25, and the free ends of retaining wings 22, 23, i.e., those disposed oppositely from articulation 25, bear against each other due to the radially inward biasing force exerted by the biased security arms 18, 19.

In this arrangement, the free ends 28 of security arms 18, 19, i.e. those directed away from top portion 20, bear, as elements of a blocking assembly, against blocking surfaces 29, 30, which are oriented in the insertion direction of fixing arrangement 15 and are configured between receiving space 4 and, as immersion spaces, immersion ducts 31, 32 extending in alignment away from receiving space 4 in the insertion direction of fixing arrangement 15, as additional elements of the blocking assembly, such that further displacement of security part 16 toward the center of security body 3 is blocked.

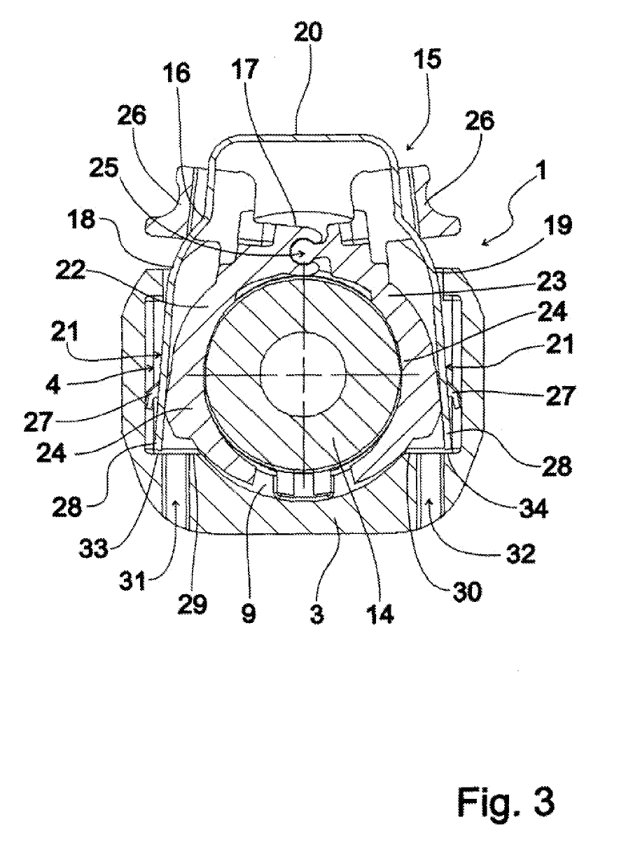

FIG. 3 shows the arrangement according to FIG. 2 with end union 14, which is configured on insertion part 10, disposed in a position located in the region of fixing arrangement 15 during the introduction of insertion part 10 at the instant when retaining wings 22, 23 are farthest apart, in a splayed-apart position, due to the passage of end union 14 through the region where retaining wings 22, 23 have the smallest diameter owing to retaining portions 24. In this arrangement, the free ends 28 of security arms 18, 19 no longer bear against blocking surfaces 29, 30, but are disposed opposite blocking surfaces 33, 34, which are aligned in the insertion direction of security part 16 and are configured radially outwardly on the opposite sides of immersion ducts 31, 32 from blocking surfaces 29, 30, such that displacement of security part 16 from the extended position toward the center of receiving space 4 continues to be blocked.

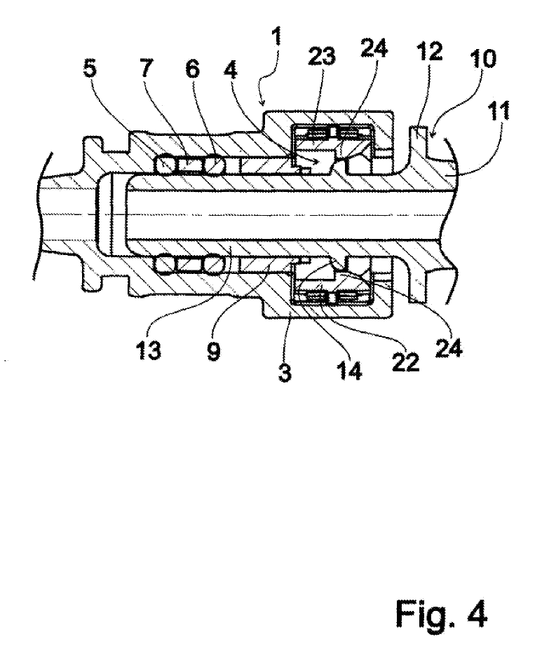

FIG. 4 is a longitudinal section of the arrangement according to FIG. 3, from which it will be clearly discerned that when end union 14 is positioned between retaining portions 24, which project radially inward in a collar-like manner into receiving space 4, the retaining wings 22, 23 are forced into the splayed-apart position, so that in this transitional phase, despite the fact that insertion part 10 appears from the outside to be nearly properly inserted in receiving part 1, it is clearly apparent from the fact that security part 16 is still protruding and is blocked against being pushed in that retaining portions 24 have not yet engaged behind end union 14.

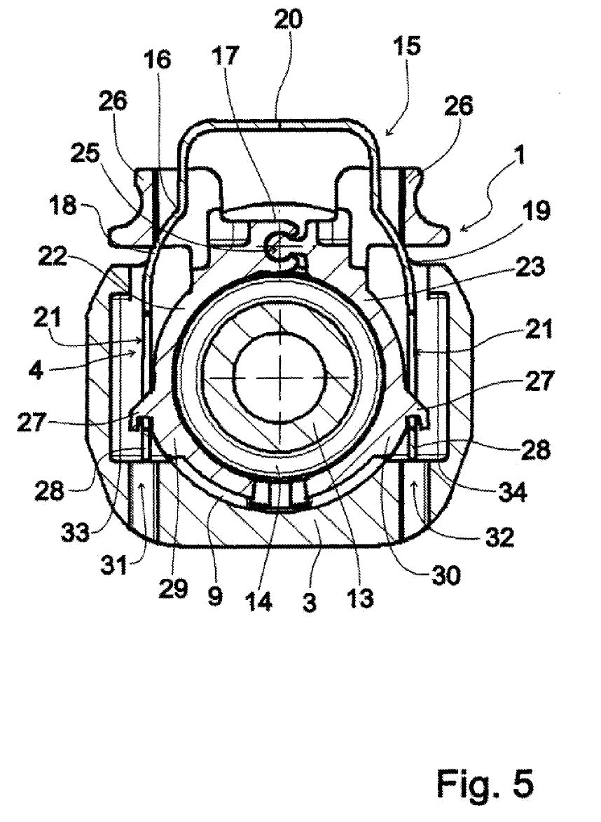

FIG. 5 shows the arrangement according to FIGS. 2 to 4 immediately after the passage of end union 14 through fixing arrangement 15, in which, due to suitable dimensioning of end union 14, security arms 18, 19 are no longer oriented in alignment with immersion ducts 31, 32. In this arrangement, security part 16 can be shifted from the extended position into a retracted position by exerting a force on top portion 20 in the direction of the center of receiving space 4.

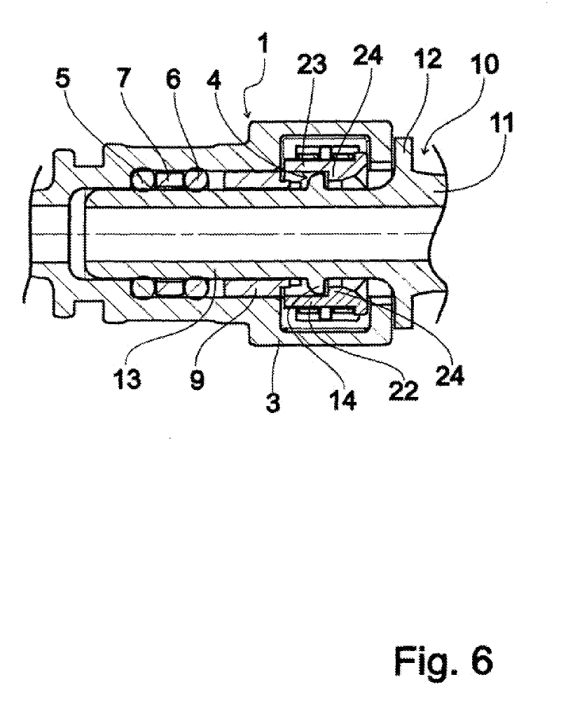

FIG. 6 is a longitudinal section of the arrangement according to FIG. 5, from which it is clear that retaining portions 24 have latched behind end union 14 and are securing insertion part 10 in receiving part 1, with portions of retaining wings 22, 23 that are situated behind retaining portions 24 in the insertion direction of insertion part 10 resting against end union 14, such that once security part 16 has been pushed in, the connection process can be recognized as having been properly completed.

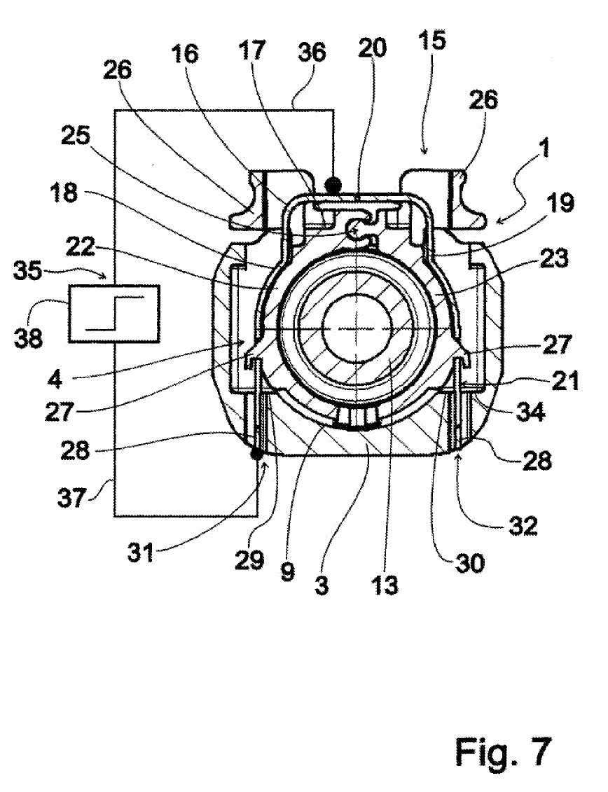

FIG. 7 shows the arrangement according to FIGS. 2 to 6 with the security part 16 in the retracted position, in which security arms 18, 19 are disposed in immersion ducts 31, 32 and extend to the outside of security body 3. In this retracted position of security part 16, retaining portions 24 of retaining wings 22, 23 engage behind end union 14 under a radially inwardly directed bias, and insertion part 10 is fixed in receiving part 1 against inadvertently being pulled out against the insertion direction.

Also depicted in FIG. 7 is an electrical measuring arrangement 35 for detecting the retracted position of a security part 16 made of metal or another electrically conductive material, and comprising substantially two contact leads 36, 37, each of which is connected by one end to an evaluator 38. When the other free end of a contact lead 36 is contacted with cover portion 20 of security part 16, and the free end of the other contact lead 37 is disposed at the external opening of an immersion duct 31, 32, an electrical connection is created between the free ends of the contact leads 36, 37 that causes a signal change, visually represented in FIG. 5, in the evaluator 38 and is therefore significant of the retracted position of security part 16.

In order to release the insertion part 10 in a comparatively simple manner, after security part 16 has been shifted from the retracted position into the extended position, the actuating structures 26 are subjected to forces that cause retaining wings 22, 23 to pivot radially outwardly into the splayed-apart position, thereby canceling the rear engagement of retaining portions 24.

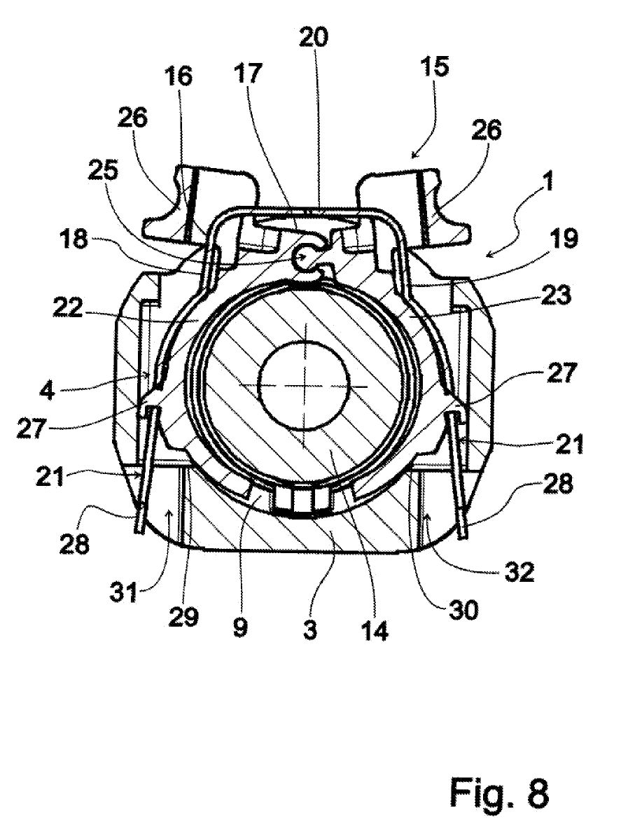

FIG. 8 shows an exemplary embodiment modified by comparison to the exemplary embodiment according to FIGS. 1 to 7, in the arrangement according to FIG. 3, with the immersion ducts 31, 32 configured as radially outwardly open immersion spaces and the blocking surfaces 33, 34 eliminated, such that security part 16 can be shifted directly from the splayed-apart position into the retracted position, and moreover, the removal of insertion part 10 can be effected by shifting retaining wings 22, 23 into the splayed-apart position without the need to move security part 16 from the retracted position into the extended position.

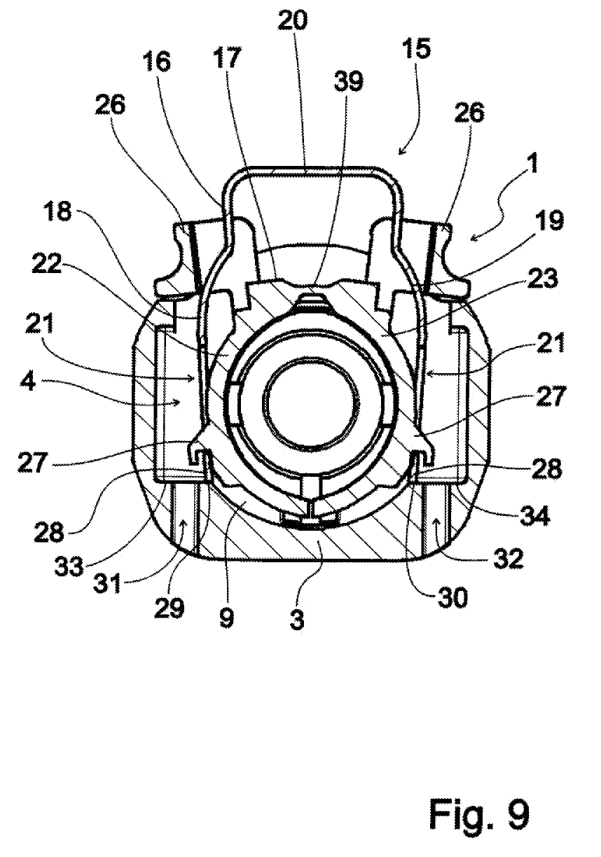

FIG. 9 is a sectional view of an exemplary embodiment modified in the region of security part 16 by comparison to the exemplary embodiment according to FIGS. 1 to 7, in which security part 16 is configured in one piece with via a pliable, flexible connection portion 39, which pivotably connects retaining wings 22, 23 to each other in the manner of a film hinge. This exemplary embodiment is distinguished by advantageously simple construction.

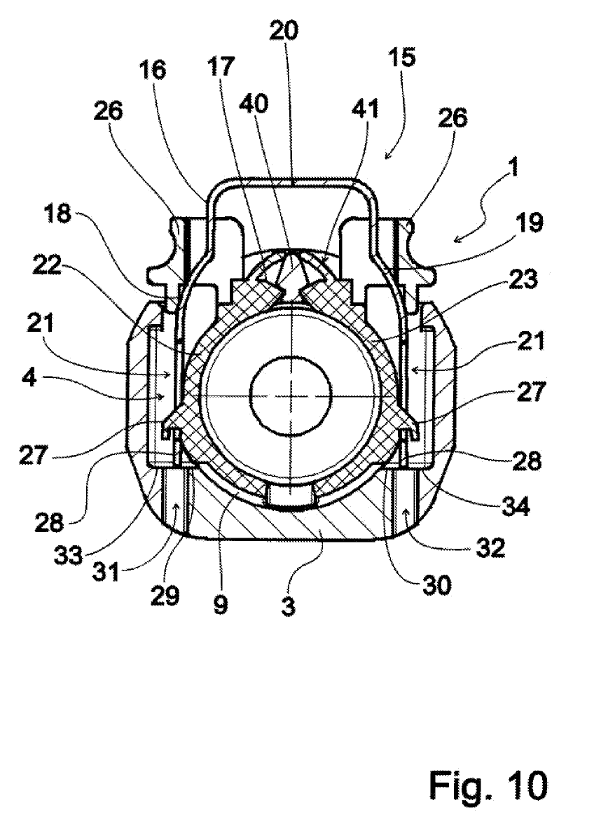

FIG. 10 is a sectional view of an exemplary embodiment further modified in the region of security part 16 by comparison to the exemplary embodiment according to FIGS. 1 to 7 and by comparison to the exemplary embodiment according to FIG. 9. In the exemplary embodiment according to FIG. 10, a separating pin 40 is formed on security body 3, and, after retaining part 17 is inserted in receiving space 4 for the first time, severs a thin bridge portion 41 originally configured between retaining wings 22, 23, causing retaining wings 22, 23 to be connected to each other by way of security part 16, rather than directly, as before. This embodiment, while being of mechanically simple construction, makes the retaining wings 22, 23 particularly easy to splay apart and endows them with a high pressure force.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-12. (canceled)

13. A fluid line coupling, comprising:
a receiving part including a receiving space;
an insertion part including an end union, said insertion part insertable into said receiving part along an insertion direction;
a fixing arrangement comprising:
a security part including two security arms and at least one retaining portion, said security part insertable into said receiving space of said receiving part and movable at right angles with respect to said insertion direction between an extended position and a retracted position, said receiving part and said security part including a blocking arrangement wherein, if said insertion part is not properly inserted in said receiving part, blocking elements respectively configured on said receiving part and on said security part engage one another to prevent said security part from shifting from said extended position to said retracted position, wherein when said end union is disposed proximate said security arms, said engagement between said blocking elements is released and said security part is movable to said retracted position, and in said retracted position, at least one said retaining portion engages behind said end union; and
a retaining part on which at least one said retaining portion is configured and which in a stationary state is disposed in said receiving space in an embracing position, said security part displaceably connected to said retaining part.

14. The fluid line coupling of claim 13, wherein said security part is U-shaped, having two oppositely disposed security arms and a pliable cover portion extending between said security arms, said security arms extending away from said cover portion and oriented to converge toward each other.

15. The fluid line coupling of claim 14, wherein said retaining part comprises two oppositely disposed retaining wings each having a retaining portion, and each retaining wing engaged with a respective security arm of said security part.

16. The fluid line coupling of claim 15, wherein said retaining part is formed as one part, said retaining wings connected to each other via a pliable connecting portion.

17. The fluid line coupling of claim 15, wherein said retaining part is formed as two parts, each part comprising a respective retaining wing.

18. The fluid line coupling of claim 17, wherein said retaining wings are connected to each other via an articulation.

19. The fluid line coupling of claim 17, wherein said retaining wings are connected to each other solely via said security part.

20. The fluid line coupling of claim 15, wherein each retaining wing includes a radially outwardly projecting protuberance, and each security arm includes an elongated opening engaged with a respective said protuberance.

21. The fluid line coupling of claim 15, wherein each retaining wing includes a respective actuating structure for pivoting said retaining wing in a radial direction.

22. The fluid line coupling of claim 14, wherein said security part is made of metal.

23. The fluid line coupling of claim 14, wherein in said retracted position, said security arms each engage in an immersion space of said receiving part.

24. The fluid line coupling of claim 14, wherein said top portion and said ends of said security arms directed away from said top portion are available for electrical contacting in said retracted position or in said extended position of said security part.
